(19) United States
(12) Patent Application Publication
(10) Pub. No.: US 2024/0363281 A1
(43) Pub. Date: Oct. 31, 2024

(54) COIL COMPONENT

(71) Applicant: SAMSUNG ELECTRO-MECHANICS CO., LTD., Suwon-si (KR)

(72) Inventors: Byeongcheol Moon, Suwon-si (KR); Sangjin Kim, Suwon-si (KR); Han Lee, Suwon-si (KR); Boumseock Kim, Suwon-si (KR)

(73) Assignee: SAMSUNG ELECTRO-MECHANICS CO., LTD., Suwon-si (KR)

(21) Appl. No.: 18/404,270

(22) Filed: Jan. 4, 2024

(30) Foreign Application Priority Data
Apr. 27, 2023 (KR) 10-2023-0055551

(51) Int. Cl. H01F 27/28; H01F 27/29

(52) U.S. Cl. CPC H01F 27/2828; H01F 27/2804; H01F 27/29

(57) ABSTRACT

A coil component according to an embodiment includes a body; a first coil embedded in the body and disposed to surround around a first core axis extending in a first direction, a second coil embedded in the body and disposed to surround around a second core axis parallel to the first core axis, and arranged in a second direction perpendicular to the first direction on the outside of the first coil; and a non-magnetic body disposed to surround the outer region of the first coil and the second coil.

### CROSS-REFERENCE TO RELATED APPLICATION

This application claims priority to and the benefit of Korean Patent Application No. 10-2023-0055551 filed on Apr. 27, 2023 in the Korean Intellectual Property Office, the entire contents of which are incorporated herein by reference.

### TECHNICAL FIELD

The present disclosure relates to a coil component.

### BACKGROUND

Along with a down-size and thinness of electronic devices such as digital TVs, mobile phones, and laptops, the down-size and thinness are also required for coil components applied to these electronic devices, in order to meet these demands, a research and development of the coil components of various types of a winding type or a thin film type are being actively conducted.

On the other hand, the demand for the components in a form of an array with the merit of reducing the mounting area of the coil components is increasing. The coil components of this array type may have a noncoupled or coupled inductor type or a mixture of the types according to a coupling coefficient or mutual inductance between a plurality of coil parts. Here, in the case of the coupled inductor, two or more coils that mutually influence each other may exist inside one body. Therefore, it is necessary to develop a structure capable of adjusting coupling coefficients between a plurality of coils with a simple structure.

### SUMMARY

Embodiments are intended to provide a coil component capable of implementing a coupled inductor capable of controlling a coupling coefficient with a simple structure.

However, tasks to be solved by embodiments of the present disclosure may not be limited to the above-described task, and may be extended in various ways within a range of technical scopes included in the present disclosure.

A coil component according to an embodiment includes a body; a first coil embedded in the body and disposed to surround around a first core axis extending in a first direction, a second coil embedded in the body and disposed to surround around a second core axis parallel to the first core axis, and disposed outside of the first coil in a second direction perpendicular to the first direction; and a non-magnetic body embedded in the body and disposed on the first coil and the second coil.

The first coil may include a first conductor and a second conductor arranged in the first direction with respect to a reference plane perpendicular to the first direction.

The non-magnetic body may be disposed along the reference plane perpendicular to the first direction between the first conductor and the second conductor.

The second coil may include a third conductor and a fourth conductor arranged in the first direction with respect to the reference plane perpendicular to the first direction.

The non-magnetic body may include a middle portion interposed between the first conductor and the second conductor and between the third conductor and the fourth conductor, and an outer circumferential portion connected to the middle portion and disposed to an outer circumference of each of the first coil and the second coil.

A thickness of the middle portion in the first direction may be thicker than a thickness of the outer circumferential portion in the first direction.

The body may include a first core portion positioned inside the first coil, and a second core portion positioned inside the second coil, and the non-magnetic body may further include an inner circumferential portion disposed to overlap each of the first core portion and the second core portion in the first direction.

The non-magnetic body may extend outward from an external circumferential surface of the first coil and the second coil.

The non-magnetic body can extend to at least one side surface of the body.

The non-magnetic body may include a through hole positioned at an edge of the non-magnetic body and penetrating a portion of the non-magnetic body in the first direction.

The through hole may include a plurality of through holes, each of which is filled by a portion of the body.

The non-magnetic body may have a processing portion positioned between the first coil and the second coil, and having a shape in which a part of the non-magnetic body is removed.

The processing portion may have a shape extending in a third direction perpendicular to the first direction and the second direction.

The non-magnetic body may be a plate shape that extends in a direction perpendicular to the first direction.

The first coil and the second coil may be disposed to be spaced apart from each other along the second direction.

The first coil and the second coil may be disposed to be in contact with each other along the second direction.

The coil component may be a thin film type inductor.

The coil component may be a multilayer type inductor.

The first coil and the second coil may be a wire-wound type coil.

A first external electrode and a second external electrode each disposed on an outer surface of the body and electrically connected to an end of the first coil, and a third external electrode and a fourth external electrode each disposed on an outer surface of the body and are electrically connected to an end of the second coil may be further included.

According to the embodiments, the coil component capable of implementing a coupled inductor capable of controlling a coupling coefficient with a simple structure may be provided.

However, it is clear that the effects of the embodiments are not limited to the above-described effects, and can be variously extended within a range that does not deviate from the spirit and region of the present disclosure.

### BRIEF DESCRIPTION OF THE DRAWINGS

FIG. 1 is a perspective view of a coil component according to an embodiment.

FIG. 2 and FIG. 3 are cross-sectional views of a coil component according to an embodiment.

FIG. 4 and FIG. 5 are cross-sectional views of a coil component according to another embodiment.

FIG. 6 is a cross-sectional view of a coil component according to another embodiment.

FIG. 7 is a cross-sectional view of a coil component according to another embodiment.

FIG. 8 is a cross-sectional view of a coil component according to another embodiment.

FIG. 9 is a cross-sectional view of a coil component according to another embodiment.

FIG. 10 is a view showing one example of a manufacturing method of a coil component of FIG. 9.

FIG. 11 is a cross-sectional view of a coil component according to another embodiment.

### DETAILED DESCRIPTION OF THE EMBODIMENTS

Hereinafter, embodiments of the present disclosure will be described in detail with reference to the accompanying drawings to allow those skilled in the art to practice the present disclosure. The drawings and description are to be regarded as illustrative in nature and not restrictive. Like reference numerals designate like elements throughout the specification. In addition, some components are exaggerated or omitted or schematically illustrated in the accompanying drawings, and the size of each component does not fully reflect an actual size.

Further, the accompanying drawings are provided only in order to allow embodiments disclosed in the present specification to be easily understood, and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like may be used to describe various configurations elements, but the constituent elements are not limited by the terms. The terms are only used for the purpose of distinguishing one constituent element from another.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

It will be further understood that terms “comprises” or “have” used in the present specification specify the presence of stated features, numerals, steps, operations, components, parts, or a combination thereof, but do not preclude the presence or addition of one or more other features, numerals, steps, operations, components, parts, or a combination thereof. In addition, unless explicitly described to the contrary, the word “comprise” and variations such as “comprises” or “comprising” will be understood to imply the inclusion of stated elements but not the exclusion of any other elements.

Further, in the specification, the phrase “on a plane” means when an object portion is viewed from above, and the phrase “on a cross-section” means when a cross-section taken by vertically cutting an object portion is viewed from the side.

Throughout the present specification, when any one part is referred to as being “coupled” another part, it means that any one part and another part are “directly or physically coupled” each other or are “indirectly or non-contact coupled” each other with the other part interposed therebetween.

In addition, in the specification, when referring to “connected to”, this does not only mean that two or more constituent elements are directly connected, but also that two or more constituent elements are electrically connected through other constituent elements as well as being indirectly connected and being physically connected, or it may mean that they are referred to by different names according to a position or function, but are integrated.

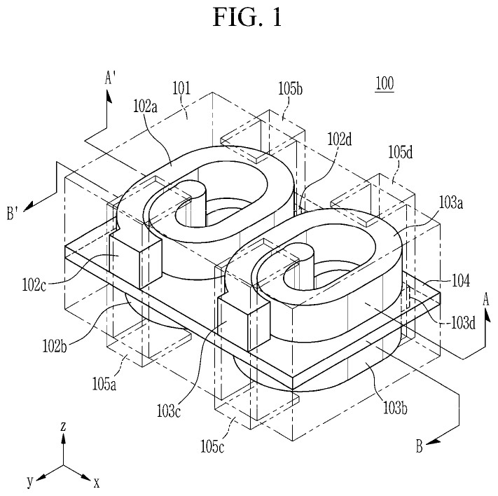

Hereinafter, a coil component according to an embodiment is described with reference to FIG. 1 to FIG. 3.

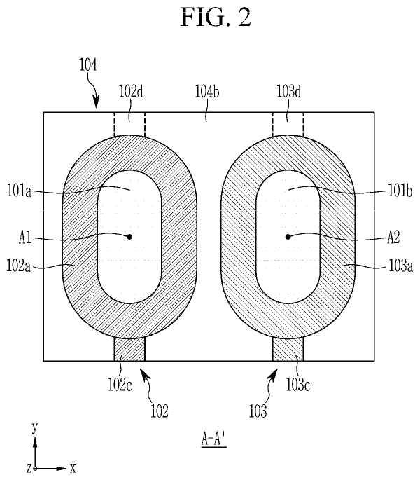

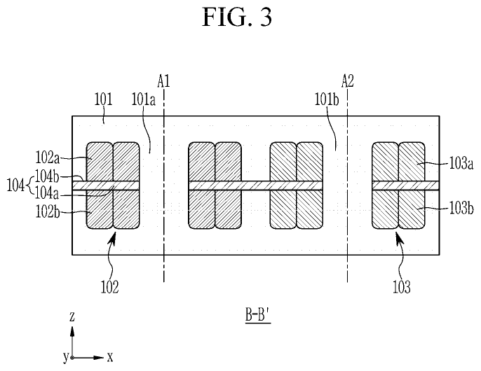

FIG. 1 is a perspective view of a coil component according to an embodiment. FIG. 2 and FIG. 3 are cross-sectional views of a coil component according to an embodiment. FIG. 2 is a cross-sectional view of the coil component in FIG. 1 taken along a line A-A′. FIG. 2 is a cross-sectional view of the coil component in FIG. 1 taken along a line B-B′.

Referring to FIG. 1, a coil component 100 according to an embodiment may include a body 101, a first coil 102, a second coil 103, a non-magnetic body 104, and first to fourth external electrodes 105a, 105b, 105c, and 105d. Here, the first core axis A1 direction of the first coil 102 and the second core axis A2 direction of the second coil 103 may be parallel to each other. For example, the coil component 100 may be a thin film type coupled inductor. The first core axis A1 and the second core axis A2 may be parallel to the first direction (a z direction). The first core axis A1 and the second core axis A2 may be extended in the first direction (the z-axis direction of the drawing).

The body 101 disposes the first and second coils 102, and 103 therein, and may form the overall appearance of the coil component 100. The body 101 is not limited as long as it is a material exhibiting magnetic characteristics, and for example, ferrite or metal magnetic powder may be filled to be formed. The ferrite may be, for example, Mn—Zn-based ferrite, Ni—Zn-based ferrite, Ni—Zn—Cu-based ferrite, Mn—Mg-based ferrite, Ba-based ferrite, or Li-based ferrite. The metal magnetic powder may include at least one selected from the group consisting of Fe, Si, Cr, Al and Ni, and for example, may be Fe—Si—B—Cr-based amorphous metal, but is not limited thereto. The particle diameter of the metal magnetic powder may be 0.1 μm to 30 μm, and may be included in a dispersed form in a thermosetting resin such as epoxy resin or polyimide.

The first coil 102, the second coil 103, and the non-magnetic body 104 may be embedded in the body 101. The first coil 102 may include a first conductor 102a and a second conductor 102b. The first conductor 102a and the second conductor 102b may be aligned in the first direction (the z direction) centered on a reference plane perpendicular to the first direction (the z direction). The first conductor 102a and the second conductor 102b may include a coil pattern of a spiral shape, and the outermost of this spiral shape may include draw-out portions 102c and 102d exposed to the outside of the body 101 for an electrical connection with the first and second external electrodes 105a and 105b. The first conductor 102a and the second conductor 102b are respectively disposed on one surface of the non-magnetic body 104, and the first conductor 102a and the second conductor 102b may be disposed on both the upper and lower surfaces of the non-magnetic body 104 as in the present embodiment. The first conductor 102a and the second conductor 102b may be a plating pattern formed using a method such as a plating process used in the art, for example, a pattern plating, an anisotropic plating, an isotropic plating, etc., and may be formed as a multi-layer structure using a plurality of these processes. As another example, the first coil 102 may be a wire-wound type coil formed by winding a metal wire such as a copper wire (Cu-wire) including a metal wire and a coating layer covering the surface of the metal wire.

The second coil 103 may include a third conductor 103a and a fourth conductor 103b. The third conductor 103a and the fourth conductor 103b may include a spiral-shaped coil pattern, and the outermost of the spiral shape may include draw-out portions 103c and 103d exposed to the outside of the body 101 for an electrical connection with the third and fourth external electrodes 105c and 105d. The third conductor 103a and the fourth conductor 103b are respectively disposed on one surface of the non-magnetic body 104, and the third conductor 103a and the fourth conductor 103b may be disposed on both the upper and lower surfaces of the non-magnetic body 104 as in the present embodiment. The third conductor 103a and the fourth conductor 103b may be a plating pattern formed using a method such as a plating process used in the art, for example, a pattern plating, an anisotropic plating, an isotropic plating, etc., and may be formed as a multi-layer structure using a plurality of these processes. As another example, the first coil 102 may be a wire-wound type coil formed by winding a metal wire such as a copper wire (Cu-wire) including a metal wire and a coating layer covering the surface of the metal wire.

The non-magnetic body 104 may be disposed to surround the outer regions of the first coil 102 and the second coil 103. The non-magnetic body 104 may be disposed along a reference plane perpendicular to the first direction (the z direction) between the first conductor 102a and the second conductor 102b. The non-magnetic body may be disposed along a reference plane perpendicular to the first direction (the z direction) between the third conductor 103a and the fourth conductor 103b. In other words, the non-magnetic body 104 may be positioned between the first conductor 102a and the second conductor 102b. In addition, the non-magnetic body 104 may be positioned between the third conductor 103a and the fourth conductor 103b. That is, the first conductor 102a and the third conductor 103a may be positioned on one surface of the non-magnetic body 104, and the second conductor 102b and fourth conductor 103b may be positioned on the opposite surface. As shown, the non-magnetic body 104 may have a plurality of penetration holes positioned in the central portion, and the penetration holes may be filled with a material constituting the body 101 to form the core portions 101a and 101b. For example, the body 101 may include a first core portion 101a and a second core portion 101b. The non-magnetic body 104 may have a plate shape extending in a direction perpendicular to the first direction (the z direction). For example, the non-magnetic body 104 may have a plate shape extended in a second direction (the x direction) and a third direction (the y direction). The second direction (the x direction) may be a direction perpendicular to the first direction (the z direction). The third direction (the y direction) may be a direction perpendicular to the first direction (the z direction) and the second direction (the x direction).

The non-magnetic body 104 may include a middle portion 104a and an outer circumferential portion 104b. The middle portion 104a may be interposed between the first conductor 102a and the second conductor 102b, and may be interposed between the third conductor 103a and the fourth conductor 103b. On the opposite surfaces of the middle portion 104a, the first conductor 102a and the second conductor 102b may be disposed side by side along the first direction (the z direction). In addition, on the opposite surfaces of the middle portion 104a, the third conductor 103a and the fourth conductor 103b may be disposed side by side along the first direction (the z direction). The middle portion 104a may be disposed to overlap the first coil 102 and the second coil 103 in the first direction (the z direction), respectively. The middle portion 104a may function as a supporting member supporting first to third conductors 102a, 102b, 103a, and 103b formed on upper and lower surfaces of the middle portion 104a.

The outer circumferential portion 104b may be connected to the middle portion 104a. The outer circumferential portion 104b may be disposed on the periphery of each of the first coil 102 and the second coil 103. The outer circumferential portion 104b may have a shape extending outward from the external circumferential surfaces of the first coil 102 and the second coil 103.

The non-magnetic body 104 may be formed of a non-magnetic material having excellent insulating properties. As the non-magnetic material for non-magnetic body 104, a resin material (e.g., a polyimide resin, an epoxy resin, and other resin materials), dielectric material ceramics (borosilicate glass, mixtures with borosilicate glass and crystalline silica, and other dielectric material ceramics), a metal oxide (e.g., alumina), a non-magnetic ferrite (eg, Zn—Ti oxide series, Zn—Cu-based ferrite), or known non-magnetic materials with excellent insulation other than these may be used. In addition, the non-magnetic body 104 may be formed of a prepreg (PPG) substrate, a ferrite substrate, or a metal-based soft magnetic substrate.

The first core axis A1 of the first coil 102 and the second core axis A2 of the second coil 103 may be parallel to each other. Here, the first core axis A1 of the first coil 102 may be defined as the central axis of the first core portion 101a positioned inside thereof as the first coil 102 is disposed to surround the first core axis A1. Similarly, the second core axis A2 of the second coil 103 may be defined as the central axis of the second core portion 101b, which is disposed so that the second coil 103 surrounds the second core axis A2 and is positioned therein.

The first core axis A1 and the second core axis A2 may be disposed parallel to the first direction (the z direction) of the body 101. Here, the first direction (the z direction) is the direction perpendicular to the first and second faces facing each other in the body 101, and the first side or the second side may be a mounting side when the coil component 100 is mounted on a substrate or the like. The first coil 102 disposed to surround the first core axis A1 and the second coil 103 disposed to surround the second core axis A2 may be disposed so that the first core axis A1 and the second core axis A2 are parallel to each other. Therefore, the second coil 103 may be horizontally disposed outside the first coil 102. In addition, the first coil 102 and the second coil 103 may be spaced apart from each other and disposed side by side along the second direction (x direction) perpendicular to the first core axis A1 and the second core axis A2.

The first to fourth external electrodes 105a, 105b, 105c, and 105d may be disposed on the outer surface of the body and connected to the first and second coils 102 and 103. For example, both ends of the first coil 102 may be electrically connected to first and second external electrodes 105a and 105b facing each other in the third direction (the y direction). In addition, both ends of the second coil 103 may be electrically connected to the third and fourth external electrodes 105c and 105d facing each other in the third direction (the y direction), respectively. The first to fourth external electrodes 105a, 105b, 105c, and 105d may be formed using a paste including a metal with excellent electrical conductivity, for example, may be a conductive paste including alone nickel (Ni), copper (Cu), tin (Sn) or silver (Ag), or an alloy thereof.

In addition, a plating layer may be provided to cover the first to fourth external electrodes 105a, 105b, 105c, and 105d. In this case, the plating layer may include one or more selected from the group consisting of nickel (Ni), copper (Cu) and tin (Sn), and for example, the nickel (Ni) layer and the tin (Sn) layer may be sequentially formed.

As described above, the non-magnetic body 104 disposed between each of the first coil 102 and the second coil 103 has the extended plate shape to surround the outer periphery of the first coil 102 and the second coil 103, and the first coil 102 and the second coil 103 are disposed side by side to have the core axes parallel to each other, so that a coupled inductor may be implemented by controlling the coupling coefficient with a simple structure.

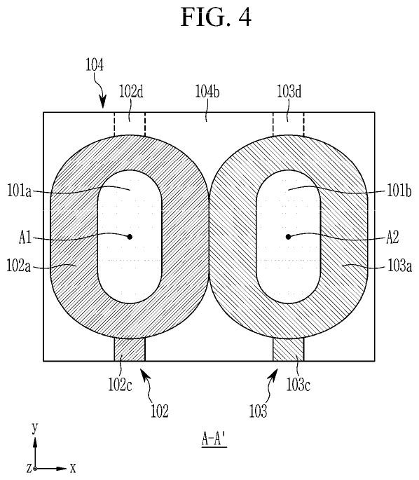

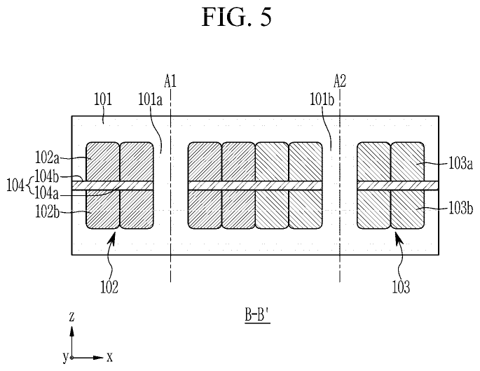

Hereinafter, the coil component according to another embodiment is described with reference to FIG. 4 and FIG. 5.

FIG. 4 and FIG. 5 are cross-sectional views of a coil component according to another embodiment. FIG. 4 is a cross-sectional view taken along the same way as that of FIG. 2. FIG. 5 is a cross-sectional view taken along the same way as that of FIG. 3.

Referring to FIG. 4 and FIG. 5, the coil component according to the present embodiment is similar to the coil component according to the embodiment described with reference to FIG. 1 to FIG. 3. The detailed description of the same constituent elements is omitted.

Referring to FIG. 4, in the coil component according to the present embodiment, unlike the coil component according to the embodiment shown in FIG. 2 and FIG. 3, the first coil 102 and the second coil 103 may disposed side by side along the second direction (x direction) perpendicular to the first core axis A1 and the second core axis A2 and may be in contact each other. Therefore, the area of the first coil 102 or the second coil 103 may be increased by the distance between the first coil 102 and the second coil 103 occurring when the first coil 102 and the second coil 103 do not come into contact with each other.

As described above, by disposing side by side so that the first coil 102 and the second coil 103 to be in contact with each other, a tension of the non-magnetic body 104 may be increased to improve a stability in the process, and the coupled inductor may be implemented by controlling a resistance, a current, and a coupling coefficient with a simple structure.

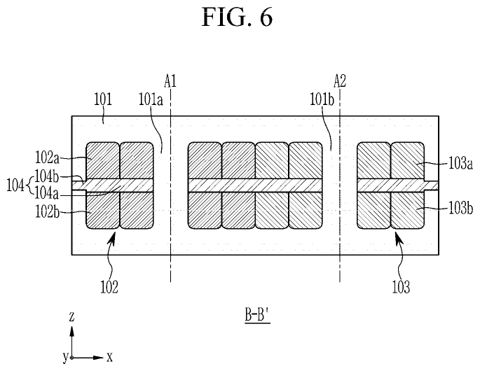

Hereinafter, the coil component according to another embodiment is described with reference to FIG. 6.

FIG. 6 is a cross-sectional view of a coil component according to another embodiment. FIG. 6 is the cross-sectional view taken along the same way as that of FIG. 3.

Referring to FIG. 6, the coil component according to the present embodiment is similar to the coil component according to the embodiment described with reference to FIG. 1 to FIG. 3. The detailed description of the same constituent element is omitted.

Referring to FIG. 6, in the coil component according to the present embodiment, unlike the coil component according to the embodiment shown in FIG. 2 and FIG. 3, the first direction (the z direction) thickness of the part of the non-magnetic body 104 may be different from the first direction (the z direction) thickness of the remaining part. Specifically, in the thickness according to the first direction (the z direction), the thickness of the middle portion 104a may be thicker than the thickness of the outer circumferential portion 104b. The outer circumferential portion 104b may be formed by processing the portion of the non-magnetic body 104 with a laser or the like.

Also, in the coil component according to the present embodiment, unlike the coil component according to the embodiment shown in FIG. 2 and FIG. 3, the first coil 102 and the second coil 103 may be disposed side by side so as to 0) be in contact each other along the second direction (the x direction) perpendicular to the first core axis A1 and the second core axis A2. Therefore, the area of the first coil 102 or the second coil 103 may be increased by the distance between the first coil 102 and the second coil 103 occurring when the first coil 102 and the second coil 103 do not come into contact with each other.

As described above, by adjusting the thickness of a part of the non-magnetic body 104, it is possible to implement the coupled inductor by controlling the coupling coefficient with a simple structure. Also, by disposing side by side so that the first coil 102 and the second coil 103 to be in contact with each other, the tension of the non-magnetic body 104 may be increased to improve a stability in the process, and the resistance, the current, and the coupling coefficient may be controlled through a simple structure.

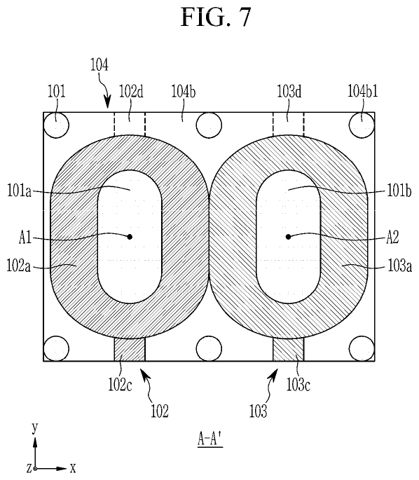

Hereinafter, the coil component according to another embodiment is described with reference to FIG. 7.

FIG. 7 is a cross-sectional view of a coil component according to another embodiment. FIG. 7 is the cross-sectional view taken along the same way as that of FIG. 3.

Referring to FIG. 7, the coil component according to the present embodiment is similar to the coil component according to the embodiment described with reference to FIG. 1 to FIG. 3. The detailed description of the same constituent element is omitted.

Referring to FIG. 7, in the coil component according to the present embodiment, unlike the coil component according to the embodiment shown in FIG. 2 and FIG. 3, the outer circumferential portion 104b may include a through hole 104b1 penetrating in the first direction (the z direction). The through hole 104b1 may be positioned on the edge of the outer circumferential portion 104b. The through hole 104b1 may include a plurality of through holes 104b1, each of which may be filled by a portion of the body.

Also, in the coil component according to the present embodiment, unlike the coil component according to the embodiment shown in FIG. 2 and FIG. 3, the first coil 102 and the second coil 103 may be disposed side by side so as to be in contact each other along the second direction (the x direction) perpendicular to the first core axis A1 and the second core axis A2. Accordingly, the area of the first coil 102 or the second coil 103 may be increased by the distance between the first coil 102 and the second coil 103 occurring when the first coil 102 and the second coil 103 do not contact each other.

As described above, by forming the through hole 104b1 in the part of the non-magnetic body 104, it is possible to implement the coupled inductor by controlling the coupling coefficient with a simple structure. In addition, by disposing side by side so that the first coil 102 and the second coil 103 are in contact with each other, the tension of the non-magnetic body 104 may be increased to improve the stability in the process, and resistance, current, and coupling coefficient may be controlled with a simple structure.

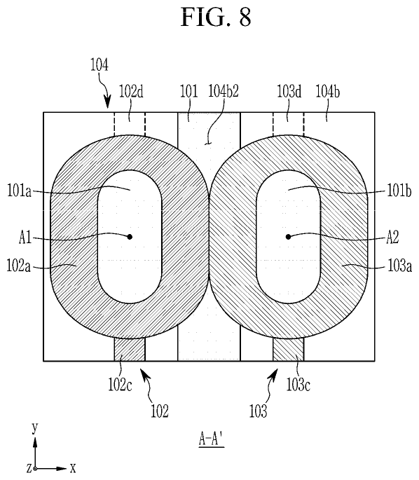

Hereinafter, the coil component according to another embodiment is described with reference to FIG. 8.

FIG. 8 is a cross-sectional view of a coil component according to another embodiment. FIG. 8 is a cross-sectional view taken along the same way as that in FIG. 2.

Referring to FIG. 8, the coil component according to the present embodiment is similar to the coil component according to the embodiment described with reference to FIG. 1 to FIG. 3. The detailed description of the same constituent element is omitted.

Referring to FIG. 8, in the coil component according to the present embodiment, unlike the coil component according to the embodiment shown in FIG. 2 and FIG. 3, the outer circumferential portion 104b may have a processing portion 104b2. The processing portion 104b2 may be positioned between the first coil 102 and the second coil 103. The processing portion 104b2 may have a shape in which a portion of the outer circumferential portion 104b is removed and a portion of the body filled. The processing portion 104b2 may have a shape extending in the third direction (the y direction).

Also, in the coil component according to the present embodiment, unlike the coil component according to the embodiment shown in FIG. 2 and FIG. 3, the first coil 102 and the second coil 103 may be disposed side by side so as to be in contact each other along the second direction (the x direction) perpendicular to the first core axis A1 and the second core axis A2. Therefore, the area of the first coil 102 or the second coil 103 may be increased by the distance between the first coil 102 and the second coil 103 occurring when the first coil 102 and the second coil 103 do not come into contact with each other. The processing portion 104b2 may have a shape that extends from a region where the first coil 102 and the second coil 103 contact to the outside of the outer circumferential portion 104b. The processing portion 104b2 may extend to at least one side surface of the body 101 in the third direction (the y direction). The processing portion 104b2 may overlap with at least one of the first coil 102 or the second coil 103 in the first direction (the z direction).

As described above, by forming the processing portion 104b2 on a part of the non-magnetic body 104, it is possible to implement the coupled inductor by controlling the coupling coefficient with a simple structure. In addition, by disposing side by side so that the first coil 102 and the second coil 103 are in contact with each other, the tension of the non-magnetic body 104 may be increased to improve the stability in the process, and resistance, current, and coupling coefficient may be controlled with a simple structure.

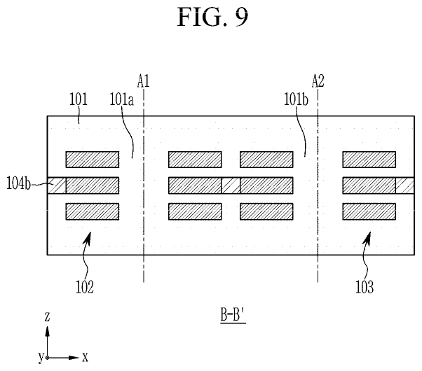

Hereinafter, the coil component according to another embodiment is described with reference to FIG. 9 to FIG. 11.

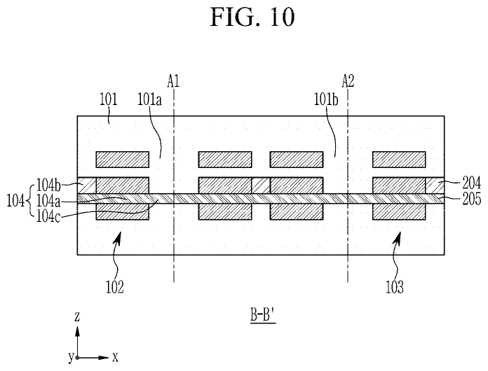

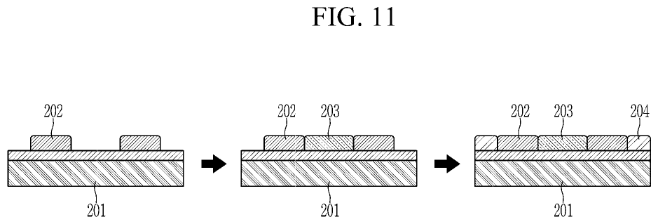

FIG. 9 is a cross-sectional view of a coil component according to another embodiment. FIG. 10 is a view showing an example of a manufacturing method of a coil component of FIG. 9. FIG. 11 is a cross-sectional view of a coil component according to another embodiment. FIG. 9 and FIG. 11 is a cross-sectional view cut in the same way as in FIG. 3.

Referring to FIG. 9 to FIG. 11, the coil component according to the present embodiment is similar to the coil component according to the embodiment described with reference to FIG. 1 to FIG. 3. A detailed description of the same constituent element is omitted.

Referring to FIG. 9 and FIG. 10, the coil component according to the present embodiment, unlike the coil component according to the embodiment shown in FIG. 2 and FIG. 3, may be a multilayer type inductor. The multilayer type inductor may be formed in a form of a stacked body in which a plurality of ceramic sheets (made of a ferrite or a low-k dielectric material) are stacked.

Referring to FIG. 11, even if the coil component is the multilayer type inductor, for example, the non-magnetic body 104 may be formed by sequentially printing the coil pattern 202, the body pattern 203, and the non-magnetic body pattern 204 on the carrier film 201.

Referring to FIG. 9, in the coil component according to the present embodiment, unlike the coil component according to the embodiment shown in FIG. 2 and FIG. 3, the non-magnetic body 104 may inly include an outer circumferential portion 104b. The outer circumferential portion 104b may be disposed outside the first coil 102 and the second coil 103. The outer circumferential portion 104b may extend outward from the external circumferential surfaces of the first coil 102 and the second coil 103. The outer circumferential portion 104b may extend to the edge of the body 101. The outer circumferential portion 104b may extend to at least one side surface of the body.

In addition, the body 101 may include a metal, for example, a FeSiCr series.

Referring to FIG. 10, in the coil component according to the present embodiment, unlike the coil component according to the embodiment shown in FIG. 2 and FIG. 3, the non-magnetic body 104 may include a middle portion 104a, an outer circumferential portion 104b, and an inner circumferential portion 104c. The middle portion 104a may be disposed between each of the first coil 102 and the second coil 103. The middle portion 104a may be disposed to overlap the first coil 102 and the second coil 103 in the first direction (the z direction). The outer circumferential portion 104b may be disposed outside the first coil 102 and the second coil 103. The outer circumferential portion 104b may have a shape extending outward from the external circumferential surfaces of the first coil 102 and the second coil 103. The inner circumferential portion 104c may be disposed to overlap the first core portion 101a and the second core portion 101b in the first direction (the z direction). Here, the non-magnetic body 104 may include, for example, a non-magnetic body pattern 204 and a non-magnetic body sheet 205. The non-magnetic body sheet 205 may be disposed to overlap the first coil 102, the second coil 103, and the body 101 along the first direction (the z direction).

As described above, the coupled inductor may be implemented by controlling the coupling coefficient with a simple structure using the non-magnetic body 104.

While the present disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims

### DESCRIPTION OF SYMBOLS

100: coil component
101: body
102: first coil
102a: first conductor
102b: second conductor
103: second coil
103a: third conductor
103b: fourth conductor
104: non-magnetic body
104a: middle portion
104b: outer circumferential portion
104c: inner circumferential portion
105a, 105b, 105c, 105d: external electrode

What is claimed is:

1. A coil component comprising:
a body;
a first coil embedded in the body and disposed to surround around a first core axis extending in a first direction;
a second coil embedded in the body and disposed to surround around a second core axis parallel to the first core axis, and disposed outside of the first coil in a second direction perpendicular to the first direction; and
a non-magnetic body embedded in the body and disposed on the first coil and the second coil.

2. The coil component of claim 1, wherein
the first coil includes a first conductor and a second conductor arranged in the first direction with respect to a reference plane perpendicular to the first direction.

3. The coil component of claim 2, wherein
the non-magnetic body is disposed along the reference plane perpendicular to the first direction between the first conductor and the second conductor.

4. The coil component of claim 3, wherein
the second coil includes a third conductor and a fourth conductor arranged in the first direction with respect to the reference plane perpendicular to the first direction.

5. The coil component of claim 4, wherein
the non-magnetic body includes:
a middle portion interposed between the first conductor and the second conductor and between the third conductor and the fourth conductor; and
an outer circumferential portion connected to the middle portion and disposed to an outer circumference of each of the first coil and the second coil.

6. The coil component of claim 5, wherein
a thickness of the middle portion in the first direction is thicker than a thickness of the outer circumferential portion in the first direction.

7. The coil component of claim 5, wherein:
the body includes:
a first core portion positioned inside the first coil; and
a second core portion positioned inside the second coil, and
the non-magnetic body further includes an inner circumferential portion disposed to overlap each of the first core portion and the second core portion in the first direction.

8. The coil component of claim 1, wherein
the non-magnetic body extends outward from an external circumferential surface of the first coil and the second coil.

9. The coil component of claim 8, wherein
the non-magnetic body extends to at least one side surface of the body.

10. The coil component of claim 1, wherein
the non-magnetic body includes a through hole positioned at an edge of the non-magnetic body and penetrating a portion of the non-magnetic body in the first direction.

11. The coil component of claim 10, wherein
the through hole includes a plurality of through holes, each of which is filled by a portion of the body.

12. The coil component of claim 1, wherein
the non-magnetic body has a processing portion positioned between the first coil and the second coil, and having a shape in which a part of the non-magnetic body is removed.

13. The coil component of claim 12, wherein
the processing portion has a shape extending in a third direction perpendicular to the first direction and the second direction.

14. The coil component of claim 1, wherein
the non-magnetic body is a plate shape that extends in a direction perpendicular to the first direction.

15. The coil component of claim 1, wherein
the first coil and the second coil are disposed to be spaced apart from each other along the second direction.

16. The coil component of claim 1, wherein
the first coil and the second coil are disposed to be in contact with each other along the second direction.

17. The coil component of claim 1, wherein
the coil component is a thin film type inductor.

18. The coil component of claim 1, wherein
the coil component is a multilayer type inductor.

19. The coil component of claim 1, wherein
the first coil and the second coil are a wire-wound type coil.

20. The coil component of claim 1, further comprising:
a first external electrode and a second external electrode each disposed on an outer surface of the body and electrically connected to an end of the first coil; and
a third external electrode and a fourth external electrode each disposed on an outer surface of the body and are electrically connected to an end of the second coil.
